(19) United States
(12) Patent Application Publication
(10) Pub. No.: US 2013/0193661 A1
(43) Pub. Date: Aug. 1, 2013

(54) Crosswise adjustable wheel

(71) Applicant: Jianhua Fan, Nashville, TN (US)

(72) Inventor: Jianhua Fan, Nashville, TN (US)

(21) Appl. No.: 13/385,053

(22) Filed: Jan. 31, 2012

(51) Int. Cl. B60G 3/01

(52) U.S. Cl. CPC B60G 3/01
USPC 280/124.15

(57) ABSTRACT

A crosswise adjustable wheel system (5) for a vehicle (1) having at least two wheels (3). The crosswise adjustable wheel system (5) has a wheel (7), an axle (11), at least one sleeve (20), and an adjustment system (4). The wheel (7) has a receiver part (10′), one end of the axle (11) connects to the receiver part (10′) of the wheel (7), near the end (10) of the axle (11), a universal axle (14) may be used while the crosswise adjustable wheel system (5) been used in front of a vehicle (1), several connect parts (18) disposed on the sleeve (20) to fix-the wheel system (5) on to a vehicle (1) with an angle (23), between the wheel (7) and ground (21) has a distance (22) on natural position (8), while the wheel (7) been pulled slant out to support position (9), the wheel (7) touched ground (21) due to the angle.

### BACKGROUND OF THE INVENTION

1. Field of the Invention

The present invention relates to vehicles those have at least 2 wheels with at least one crosswise adjustable wheel system to support and balance the vehicle body while stopping or turning. The at least one crosswise adjustable wheel system can be adjusted either by hand or by feet. The location of the crosswise adjustable wheel may be vary, either nearly front, middle, or rear of the vehicle body. The crosswise adjustable wheel system fixed on a vehicle with an angle and has a distance between the wheel and ground while the crosswise adjustable wheel is on nature position. So that the crosswise adjustable wheel extend out slant and reached ground on support position. Methods of adjustment can be wire with tension spring, oil pressure cylinder, or electric motor. The crosswise adjustable wheel system can be used on motor cycle, scooter, electric bicycle, and possible add an outer covering to them. In other words, motor cycle, scooter, and electric bicycle can be made into car like vehicle. Also, our wheel vehicles can be reduced the width a lot using crosswise adjustable wheel system.

2. The Prior Art

Most two wheel vehicle has no outer covering because riders have to stand on ground to support it while stopping. Some two wheel vehicle added outer covering while using adjustable support wheels. But those adjustable support wheels are not easy to operate, and can't provide good balance while makes turning. All four wheel car have to have a certain width to avoid capsize while makes turning.

It can be seen then that there is a need for at least two wheel vehicles with crosswise adjustable wheel system to support and balance them while stopping or turning, and simplify the operating of support wheels. Also, there is a chance for motor cycle, scooter, and electric bicycle to add outer covering, and four wheel car to reduce the width.

### SUMMER OF THE INVENTION

The present invention relates to at least two wheel vehicles with at least one crosswise adjustable wheel system.

The present invention disclosed a crosswise adjustable wheel system for at least two wheel vehicles to support or balance the body while making a stopping or turning, or made them into car like vehicle, or made the body of four wheel vehicles much narrow. More than two crosswise adjustable wheel systems may be used in one vehicle, it depends on the needs. Also, the crosswise adjustable wheel systems in one vehicle can be adjusted either by one adjustment system or two adjustment system, or said may be adjusts them separately for different proposal.

In one embodiment of the present invention, a motor cycle with two crosswise adjustable wheel systems, one on left side and another one on right side of the motor cycle, the wheels adjusted separately, the location they are fixed on may be vary, such as near front, middle, or rear of the vehicle. The wheel systems are controlled/ adjusted by feet or hands.

Still in one embodiment, adjustment methods of crosswise adjustable wheel system may be vary, such as machinery/wire with tension spring, oil pressure cylinder, electric motor and so on.

In another embodiment, a motor cycle been made into car like vehicle, in other words, an outer covering been added to a motor cycle. Also, four crosswise adjustable wheel systems may be used in one vehicle: two at front and two at rear, the front two wheel systems may be connected to the vehicle's string system.

More in one embodiment, crosswise adjustable wheel systems been used in a three wheels motor cycle or car. If the wheels are ranged one on front and two on rear and the front wheel located in the centre of the vehicle, two crosswise adjustable wheel systems will be used: one on the left side and another on the right side of the vehicle. If front wheel of the vehicle located on the left side, then one crosswise adjustable wheel system may be used on the left side of the vehicle only. Also, if the wheels are ranged two on front and one on rear centre of the vehicle, then two crosswise adjustable wheel systems may be used at rear of the vehicle.

Furthermore, in one embodiment, two or four crosswise adjustable wheel systems been used on a four wheels car, so that, the car can be made into much narrow of the width to reduce air resistance on driving.

These and various other advantages and feature of novelty which characterize the invention are pointed out with particularly in the claims annexed hereto and form a part hereof. However, for a better understanding of the invention, its advantage, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

A better understanding of the construction and operational characteristics of a preferred embodiment(s) can be realized from a reading of the following detailed description especially in light of the accompanying drawing in which like reference numerals in the several views generally refer to corresponding parts.

FIG. 1 is a top view of a traditional motor cycle with crosswise adjustable wheel systems apparatus in accordance with the present invention.

FIG. 2 is a top view of a three wheel vehicle with two crosswise adjustable wheel systems apparatus in accordance with the present invention.

FIG. 3 is a top view of another three wheel vehicle with one crosswise adjustable wheel system apparatus in accordance with the present invention.

FIG. 4 is a perspective view of a crosswise adjustable wheel system.

FIG. 5 is an exploded back view of a two wheel vehicle with two crosswise adjustable wheel systems apparatus, the wheels adjusted by oil pressure cylinder.

FIG. 6 is an exploded back view of a two wheel vehicle with two crosswise adjustable wheel systems apparatus, the wheels adjusted by electric motor.

FIG. 7 is left side view of four wheels narrow body vehicle with two crosswise adjustable wheel systems.

FIG. 8 is a perspective view of steering wheel system with automatic motor control system for crosswise adjustable wheel.

### DETAILED DESCRIPTION OF THE PREFERRED EMBODIMENT

The present invention relates to an at least two wheel vehicle with at least one crosswise adjustable wheel system.

In the following description of the exemplary embodiment, reference is made to the accompanying drawings which form a part hereof, and in which it is shown by way of illustration the specific embodiments in which the invention may be practiced. It is to be understood that other embodiment may be utilized as structural changes may be made without departing from the scope of the present invention.

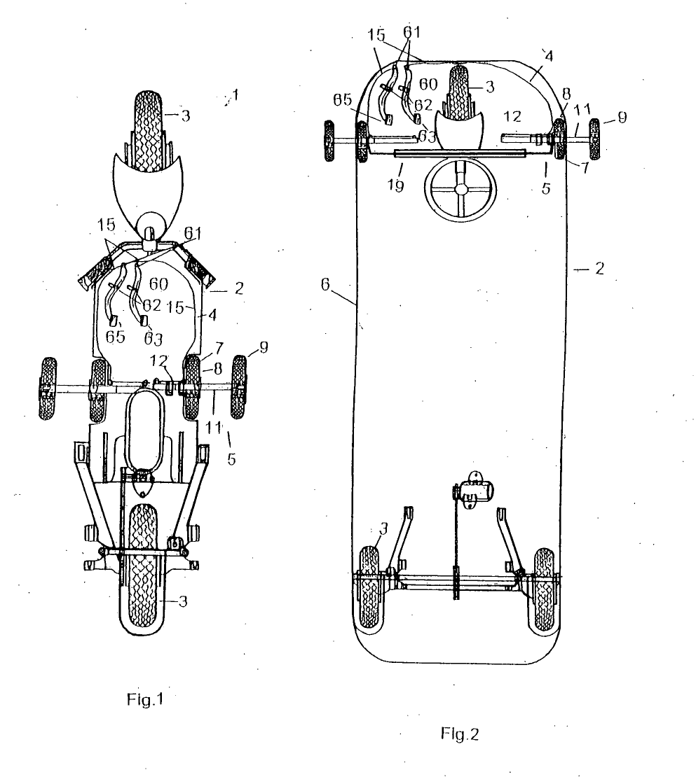

Referring now to FIG. 1, there is, generally illustrated by reference numeral 1, a two wheel vehicle 2 with two crosswise adjustable wheel systems 5. The vehicle's wheels 3 arranged in tandem along the longitudinal axis of a regular vehicle 2 in accordance with the principles of the present invention. Two crosswise adjustable wheel systems 5 are located in middle of the regular two wheel vehicle 2. One is on left side and another on right side of the regular vehicle 2.

In FIG. 1, the crosswise adjustable wheel system 5 has a wheel 7, an axle 11, an axle sleeve 12, and an adjustment system 4. The axle sleeve 12 holds the axle 11, the wheel 7 is fixed on one end of the axle 11, the sleeve 12 fixed on to the regular vehicle 2. Numeral 9 shown the crosswise adjustable wheel 7 is on support position.

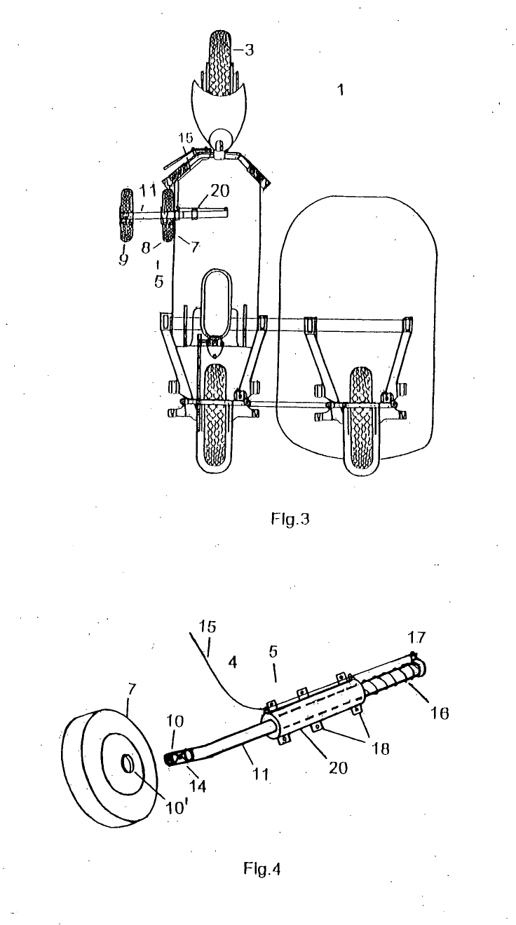

Still in FIG. 1, the crosswise adjustable wheel 5 is operated by an adjustment system 4. The adjustment system 4 has a wire 15, a pedal 60, and a tension spring 16 (shown in FIG. 4). It is to be understood that other embodiment, such as a handle (shown in FIG. 3, numeral 8), may be used in FIG. 1 to replace the pedal 60. This means that the feet operation changes to hand operation.

FIG. 2 shows a three wheel vehicle 1 has a regular vehicle 2 and two crosswise adjustable wheel systems 5. The regular vehicle has three wheels, one wheel located at front in middle and other two wheels located at rear of the vehicle. Two crosswise adjustable wheel systems 5 located near front of the vehicle 2. The crosswise adjustable wheel systems 5 and the adjustment system 4 are the same in FIG. 1. An outer covering 6 had been added in this vehicle.

Still in FIG. 2, a universal axle 14 for crosswire adjustable wheel system may be used for easy turning because the wheels 7 located at front of the vehicle 2. In another way, the two crosswise adjustable wheel systems 5 can be connected to turning system of vehicle's front wheel 3 through a connection part 19. So that, the three wheels: the vehicle's front wheel 3 and two crosswise adjustable wheel 7 kept in same direction while making a turn.

FIG. 3 is another style of three wheel vehicle, one crosswise adjustable wheel system 5 been used in this vehicle. The wheel system 5 located on left side and near middle of the vehicle 2. A handle 13 been used for adjustment system 4. More crosswise adjustable wheel system may be used on this kind of vehicle if it's needed.

FIG. 4 shows a crosswise adjustable wheel system 5 in detail. Adjustment system 4 for this crosswise adjustable wheel is mechanical. The crosswise adjustable wheel system has a wheel 7, an axle 11, a sleeve 20, and adjustment system 4. The wheel 7 has a receiver part 10′, one end 10 of the axle 11 connect to the receiver part 10′ of the wheel 7, near the end 10 of the axle 11, a universal axle 14 may be used while the crosswire adjustable wheel system 5 been used in front of a vehicle in FIG. 2, another end of the axle 11 has a hook 17 for fixing wire 15, and a tension spring 16 applied, several connect parts 18 disposed on the sleeve 20 to fix the crosswise adjustable wheel system 5 on to a vehicle with an angle 23. It is appreciated that other sleeves may be used, for example, two or more shorter sleeves 12 in FIGS. 1 and 2 instead of the longer sleeve 18.

Still in FIG. 4, the adjustment system 4 includes a tension spring 16, a wire 15, a wire hook 17 and a pedal 60 (shown in FIG. 2) or a handle 13 (shown in FIG. 3). While push the pedal 60 down or tighten the handle 13, the crosswise adjustable wheel 7 been pulled slant out from natural position 8 to support position 9 due to the angle 23. When release the pedal 60 or the handle 13, the tension spring 16 push the wheel 7 from support position 9 back to the natural position 8.

The adjustment system 4 which is shown in FIG. 4 is mechanical. In FIG. 5, oil pressure cylinder 31 has been used in the crosswise adjustable wheel system 5. There is a distance 22 between the crosswise adjustable wheel 7 on natural position 8 and ground 21. Numerals 33 and 35 are oil pipes. While push pedal 60 (in FIGS. 1 and 2) down, oil into cylinder 31 through pipe 33, the oil pushed the wheel 7 at natural position 8 slant out to support position 9, and the wheel 7 touched on ground 21. A tension spring may be used in this device instead of oil pipe 35. It is appreciated that all crosswise adjustable wheel in this invention has a distance 22 between the wheel 7 at natural position 8 and ground 21, in other words, the wheel 7 is higher than the vehicle wheels 3, and the crosswise adjustable wheel system 5 has an angle on a vehicle, and the wheel 7 just touched ground 21 when it been pushed out to the support. position 9, and the crosswise adjustable wheel system 5 on left side and right side of vehicle may be adjusted separately.

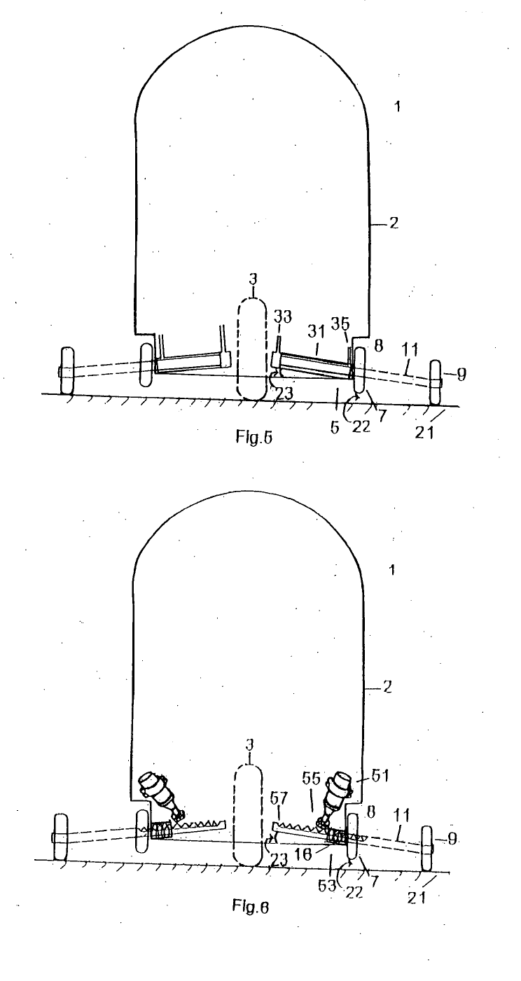

Electric motor has been used in FIG. 6 to adjust the wheel 7. The electric motor 51 has a rack wheel 55, and rack rail 57 been disposed on the axle 11. Tension spring 16 also applied in the wheel system 5. The motor controlled by a switch (not shown in Figures). While turn on the switch, the motor pushed the wheel 7 at 8 position to support position 9. The tension spring 16 push the wheel 7 back to natural position 8 when turn the switch off. An automatic control system (80 in FIG. 8) may be used in this control system instead of the switch.

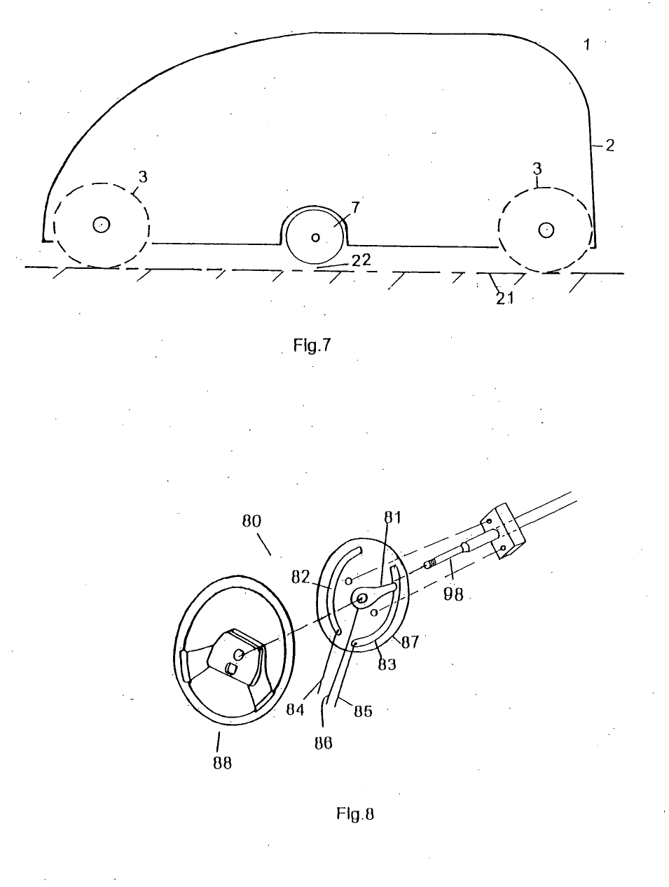

FIG. 7 is a side view of a car with crosswise adjustable wheel systems. The car 1 can be two, three or four wheels. The crosswise adjustable wheel systems 5 located in middle of the car 1. The wheel 7 is on the natural position and has a distance 22 to ground 21.

FIG. 8 shows an automatic motor control system 80 which had mentioned above. The control system 80 is fixed into a turning wheel system 88. The control system 80 has a pad 87 which can't be turned with turning wheel, two metal panel 82 and 83 been fixed on the pad 87, one end of wire 84 connected to panel 82, and another end of wire 84 connected to the electric motor of right side crosswise adjustable wheel system 5 of the vehicle 1. One end of Wire 85 connected to panel 83, and another end of wire 85 connected to the electric motor on left side crosswise adjustable wheel system 5 of the vehicle 1. A touchable panel 81 is fixed on to axle 89 of turning wheel 88 and turned with turning wheel. One end of wire 86 connected to panel 81 and another end of wire 86 connected to electric source. While making a left turn, the panel 81 touched the panel 82, the electric motor of right side crosswise adjustable wheel system 5 push the wheel 7 from natural position 8 to support position 9. While making a right turn, the panel 81 touched the panel 83, the electric motor of left side crosswise adjustable wheel system 5 push the wheel 7 from natural position 8 to support position 9. When the turning wheel 88 backed to centre/ natural position, the electric motors lost power, the tension spring 16 push the wheel 7 back to natural position 8.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. An at least two wheel vehicle apparatus, comprising:
an at least two wheel vehicle; and
at least one crosswise adjustable wheel system, the at least one crosswise adjustable wheel system having a wheel, an axle, at least one sleeve; and
the wheel fixed on the axle, the axle held by at least one sleeve, connect parts on the sleeve fixed the crosswise adjustable wheel system to the vehicle with an angle.

2. The vehicle apparatus of claim 1, further comprising an adjustment system, wherein the adjustment system fixed into the vehicle and connecting to the crosswise adjustable wheel system, the adjustment system adjusts the crosswise adjustable wheel.

3. The vehicle apparatus of claim 1, wherein the crosswise adjustable wheel having a distance to ground at natural position and reached ground when the wheel been adjusted to support position.

4. The vehicle apparatus in claim 1, wherein a universal axle may be used when the crosswise adjustable wheel system located on the near front of the vehicle.

5. The vehicle apparatus in claim 1, wherein the crosswise adjustable wheel system may be connected to the vehicle turning wheel system when the it's located on the near front of the vehicle.

6. The vehicle apparatus in claim 2, wherein main parts of the adjustment system are wire, tension spring.

7. The vehicle apparatus in claim 2, wherein main part of the adjustment system is oil pressure cylinder.

8. The vehicle apparatus in claim 2, wherein main part of the adjustment system is electric motor.

9. The vehicle apparatus in claim 2, wherein the adjustment system operated by hand.

10. The vehicle apparatus in claim 2, wherein the adjustment system operated by feet.

11. The vehicle apparatus in claim 6, wherein one end of the wire connecting to the axle and another end of the wire connecting to a handle if the adjustment system operated by hand, or a pedal if the adjustment system operated by feet.

12. The vehicle apparatus in claim 6, wherein the tension spring fixed on the axle, while release the handle or the pedal, the tension spring pushed the axle/wheel back to natural position.

13. The vehicle apparatus in claim 7, wherein oil pushed the axle/wheel from natural position to support position while pushes down the pedal, and oil pushed axle/wheel back to natural position from support position while release the pedal.

14. The vehicle apparatus in claim 7, wherein only one oil pipe connected to the oil pressure cylinder, and one tension spring fixed on the axle, oil pushed the axle/wheel from natural position to support position while pushes down the pedal, and the tension spring pushes the axle/wheel from support position to natural position while release the pedal.

15. The vehicle apparatus in claim 8, wherein the electric motor controlled by a switch, the switch operates by hand or by feet.

16. The vehicle apparatus in claim 8, wherein the electric motor controlled by an automatic control system, the system fixed into the turning wheel system.
